(19) United States
(12) Patent Application Publication
(10) Pub. No.: US 2010/0139109 A1
(43) Pub. Date: Jun. 10, 2010

(54) Instant reading oil dipstick

(76) Inventor: John Anderson Armistead, Easley, SC (US)

Correspondence Address: John A. Armistead, 306 East First Avenue, Easley, SC, 29640-3064, US

(21) Appl. No.: 12/217,281

(22) Filed: Jul. 3, 2008

(51) Int. Cl. G01F 23/04

(52) U.S. Cl. 33/727; 33/729

(57) ABSTRACT

The present instant reading oil dipstick automatically extracts a representative column of oil from the crankcase oil reservoir. Such is done inside of a translucent fluoroplastic tube. A machined brass slide valve, with sealing O-rings, fits inside of the metal dipstick tubing leading into the engine crankcase. When the dipstick is withdrawn for checking oil level, the slide valve automatically closes over an air vent in the plastic tubing, thus preventing the oil that is inside the bottom of the tubing from running out. The oil level can be ascertained, easily—even in low light levels—without have to wipe off the oil from the outside of the dipstick, and without having to reinsert the dipstick one or more times.

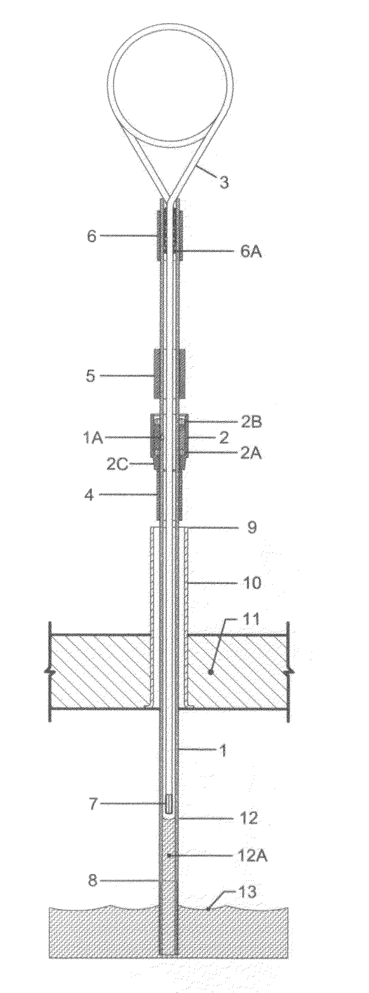

### BACKGROUND OF THE INVENTION

The most commonly used conventional oil dipsticks are thin metal strips that extend into the oil of a vehicle's crankcase. During the running of the engine, oil is sprayed, or gets splattered, on the metal strip, above the oil level that is in the crankcase oil reservoir. To accurately read the level of the oil using conventional metal dipsticks, the checker must remove the dipstick from the metal dipstick tube, wipe it off with a rag or tissue, then, fully reinsert the dipstick. That conventional dipstick must then be withdrawn a second time, while the checker looks for a film of oil that corresponds to the level of oil that has settled into the oil reservoir.

Fresh oil—and especially synthetic oils—are nearly clear in color. With those oils the only way to determine the level is to tilt the dipstick back and forth in the light to look for shine differences between the metal that's coated in oil, and the remaining metal portion that the checker just wiped clean of oil. But a much too common problem exists in doing the above. Namely, when the metal dipstick was withdrawn the first time, lots of loose oil dripped into the metal dipstick tube through which the dipstick was withdrawn. Now, when the conventional dipstick is reinserted, it passes back through that oil-spattered dipstick tube and becomes coated with drops of oil at random locations.

When the oil level checker withdraws the dipstick a second time, it is common to find a drop or more of loose oil near the marked-off indicator range at the bottom of the dipstick. Because of the confusion caused by those loose oil drops, often the checker must wipe off the dipstick one or more additional times to verify where the actual oil level is. Sometimes checkers must make three or four withdrawals of the conventional dipstick to be certain of the oil level.

The above checking for oil level requires the use of an available rag or tissue. Sometimes the checking is motivated by a dashboard warning light or gage. Prudent drivers will pull to the roadside and immediately check the oil level. Many a driver (including this writer) has had to walk up and down the side of the road to find a dirt-coated piece of paper, dry grass, or even a leaf with which to wipe off the dipstick! And when you are driving at night, and don't have fresh batteries in your flashlight, checking the oil level is simply impossible.

The present invention is for the expressed purpose of solving all of the above dipstick reading problems. It's explained below.

### BRIEF SUMMARY OF THE INVENTION

Spattered or dripped oil can confuse the reading of conventional metal strip type dipsticks. That's why my instant reading oil dipstick measures the levels inside of a long plastic tube. When the end of that tube extends into the oil reservoir, the oil will coat both the outside and the inside of the tube. Oil can flow up into the plastic tube—which is completely open on its bottom end—because there is a single small vent hole in the otherwise air tight construction of the upper part of the dipstick assembly.

To allow the oil to flow into the plastic tube, the vent hole must be open the entire time that the dipstick is inserted. But by placing a small brass slide valve just above the vent hole, such slide valve can be made to close over the vent hole, almost instantly, when the dipstick is removed. With the vent hole thus closed, the representative depth of the oil inside the plastic tube is prevented from draining back out of the open end of the tube at its bottom. Such is because a vacuum is created in the upper tube which is sufficiently strong to counter the weight of the oil that is now trapped in the plastic tube.

When the instant reading oil dipstick is withdrawn from the metal dipstick tube, the oil level can be determined whether or not there is a rag or tissue available for wiping off the dipstick. Because the plastic is translucent, the color of the oil in the tube is immediately discernable. If the oil being used happens to be water clear, the level can be determined by looking for the darker looking curved top of the oil surface. That surface refracts the light so that the top is visible as a darker area. Additionally, because the oil also coats the outside of the dipstick, even if no wiping has been done, the level of the oil around the plastic tube is more easily read than on a flat metal strip that must be tilted in the light to see the shine of the oil.

Unless there is total darkness, the instant reading oil dipstick can be read by holding the dipstick between the checker and any light colored or lit surface in the background. The darker curved surface of the top of the oil in the plastic tube can allow readings to be made. As will be explained in more detail in the following, the “FULL” line in the instant reading oil dipstick is the tip of a small stiffening wire that is located inside the plastic tube. Such wire is unitary and integral with the dipstick's handle. In low light conditions, the tip of that wire will show up as dark object when held between the checker and a light colored or lit background.

### BRIEF DESCRIPTION OF THE VIEW OF THE DRAWING

Typically, dipsticks are about two feet long. The single drawing which embodies the instant reading oil dipstick is drawn to scale, but the length, only, is truncated or shortened. All of the salient features of the dipstick are shown in a longitudinal SECTIONAL VIEW that is cut through the diameter of the cylindrical tubes and valve parts. Because the looped wire handle has both of its ends extending side-by-side into the plastic tube, such wire is actually being seen in elevation, not in section. To avoid confusion, the simple, coiled, spring-like, finger loop is shown as if it is in elevation, too. Otherwise, there would be a long angular section cut through two sides of the wire finger loop—which would, if shown, tend to confuse the very simple dipstick design. Also, the instant reading oil dipstick is shown as a straight part. In actuality, most metal dipstick tubes are curved. The tempered, stainless steel wire inside the plastic tube allows the assembly to bend, easily, to conform to the curvature of most metal dipstick tubes. But the instant reading oil dipstick will return to straightness when it is withdrawn, as for measuring the oil level.

### DETAILED DESCRIPTION OF THE INVENTION:

The present invention measures the level of oil, 13, inside of a vehicle's crankcase, 11, by inserting a small, translucent, high-temperature-resistant, fluoroplastic tubing, 1, through the engine's metal dipstick tubing, 10, and physically extracting a column of oil, 12A, which corresponds to the depth of oil in the reservoir of the crankcase, 13. Such is made possible by the fact that the tubing, 1, is sealed air-tight by thermal resistant cyanoacrylate gel glue, 6A. And a single small vent hole, 1A, will allow the oil in the reservoir below surface, 13, to come to a corresponding level, 12, inside of the dipstick tubing, 1.

The drawing shows vent hole, 1A, covered over by a machined brass slide valve, 2. Such slide valve, 2, has internal O-rings, 2A, below, and 2B, above, which are compressed against both the O.D. of tubing, 1, and the I.D. of slide valve, 2. The spacing of the O-rings is maintained via a close fitting bronze bushing which is lubricated with oil between its I.D. and the O.D. of tubing, 1, to provide additional air seal when such bushing is positioned over vent hole 1A. Slide valve, 2, is free to move up and down a short distance. In the top-most, or open position, the O-ring, 2B, of slide valve, 2, will abut the bottom edge of brass stop bushing, 5, which is permanently bonded into position on tubing, 1. In the bottom-most, or closed position (as is shown), the bottom edge of slide valve, 2, will abut the top edge of brass stop bushing, 4, which is permanently bonded into position on tubing, 1. Bonded brass bushing, 6, maintained the roundness of tubing, 1, while handle, 3, was being glued, 6A, inside of tubing, 1.

Slide valve, 2, has a cone shaped lower end, 2C. The I.D. of slide valve, 2, just beneath cone, 2C, is intentionally made large enough so as not to be air tight. That will allow the vent hole, 1A, to be open, even though the lower body of slide valve, 2, is over the vent hole. The vent hole, 1A, can thus be located right next to the internal O-ring, 2A, allowing the air seal to be affected almost immediately once handle, 3, is lifted by the oil checker. In the valve open position, cone, 2A, will fit air-tight inside the I.D. of metal dipstick tubing, 10. Cone, 2A, will be pushed into such position via bonded bushing, 5, which enters the upper I.D. of slide valve, 2, and presses against O-ring, 2B. Then, the dipstick assembly, as a unit, can be pushed down via handle, 3, into metal dipstick tubing, 10. The O.D. of bushing, 4, serves as a guide to help center the slide valve, 2, in the metal dipstick tubing, 10.

A tempered, stainless steel wire handle, 3, is looped at the top to allow the user to grasp such by inserting one finger. The handle, 3, has two long ends that extend side-by-side into the plastic tubing, 1, to stiffen such tubing. On the bottom-most end of wire, 3, is a painted indicator marking, 7. Such corresponds to the FULL position for the oil, 13, as is recommended by the engine manufacturer. The ADD line on the dipstick is either a stained and/or acid etched area from line, 8, down to the bottom of tube, 1, or: Alternatively, the ADD line, 8, may be a short, internal, and snug-fitting tubing piece that is slid up to the ADD line, 8. The latter method is intended for after-market usage and isn't shown on the drawing.

The principle which allows the slide valve to both seal the crankcase, 11, and to properly actuate, depends on the fact that the friction between the cone end, 2C, of slide valve, 2, and the I.D. of metal tubing, 10, will exceed the friction between the I.Ds. of O-rings, 2A and 2B, of slide valve, 2, and the O.D. of the plastic dipstick tubing, 1. When the oil checker first lifts the dipstick using the finger loop of wire handle, 3, crankcase sealing cone, 2C, grips the I.D. of metal dipstick tubing, 10, tightly enough so that the plastic tubing, 1, will slide up inside of slide valve, 2, to seal over vent hole, 1A. When the wire handle, 3, has moved upward just 1/16 of an inch, O-ring, 2A, of slide valve assembly, 2, will have covered over and sealed, vent hole, 1A. Slide valve sealing cone, 2C, remains in place inside of the I.D. of metal tubing, 10, until bushing, 4—which is permanently bonded to tubing, 1—forces cone, 2C, out of position and upward. Then, the column of oil, 12a, in tubing, 1, up to level, 12, which corresponds to level, 13, can be extracted, because of the vacuum created in the now sealed tubing, 1, above oil level, 12.

Following the reading of the oil level through the translucent tubing, 1, the oil checker reinserts the dipstick assembly, until cone, 2C, abuts and seals against the top edge, 9, of metal dipstick tubing, 10. Once the slide valve, 2, is seated against edge, 9, tubing, 1, can slide down until air vent hole, 1A is no longer between O-rings 2A and 2B. In the fully inserted position, the vent hole 1A will have access to the air (or vacuum) inside of crankcase, 11. Such air access will allow the level of the oil column, 12A to match the level of oil, 13, in the crankcase oil reservoir, even as the latter level changes due to oil usage or leaks. The freely variable height of oil column, 12A, is what allows the representative height, 12, to be read by the oil checker.

Since oils are sometimes nearly water clear, the curved top surface, 12, of the oil column, 12A, acts to refract the light passing through the plastic tubing, 1. That will cause a visible dark band, even if the oil itself has no color. Since oil, also, will coat the outside of tubing, 1, that coating, combined with the dark band just described, will allow reading the oil level under low light conditions that would prevent a conventional dipstick from being read.

1. An instant reading, automotive oil dipstick assembly which extracts a representative column of oil inside of a translucent, temperature and chemical resistant, fluoroplastic tubing.

2. A dipstick, as in 1, above, that is reinforced by a unitary, tempered, stainless steel handle.

3. A dipstick, as in 1, above, that is actuated and sealed via a machined brass slide valve having two internal O-rings.

4. A wire handle, as in 2, above, which is painted on its lower tip to serve as the FULL indicator for the oil.

5. Plastic tubing, as in 1, above, that is stained and/or acid etched, on its lower end to serve as the oil ADD line.

6. A brass slide valve as in 3, above, which is constrained between brass bushings that are bonded to the O.D. of the plastic tubing as in 1, above.

7. A tubing as in 1, above, that has a small vent hole that is so located between the brass bushings of 6, above, that the slide valve will close over said vent hole when the dipstick handle has been extracted a fraction of an inch.

8. A tubing as in 1, above, which is bonded air tight to the handle of 2, above, using thermal resistant cyanoacrylate gel glue.

9. A dipstick assembly which will allow reading oil level through the translucent tubing without having to wipe off the oil and reinsert the dipstick one or more times.
